(19) United States
(12) Patent Application Publication
(10) Pub. No.: US 2026/0080215 A1
(43) Pub. Date: Mar. 19, 2026

(54) DATA DIVERSITY AUGMENTATION METHOD AND DEVICE THROUGH DECISION BOUNDARY RECOGNITION AND RECONSTRUCTION

(71) Applicant: CHUNG ANG UNIVERSITY INDUSTRY ACADEMIC COOPERATION FOUNDATION, Seoul (KR)

(72) Inventors: YOUNG BIN KIM, Seoul (KR); KYO HOON JIN, Gyeonggi-do (KR)

(21) Appl. No.: 19/326,905

(22) Filed: Sep. 12, 2025

(30) Foreign Application Priority Data
Sep. 13, 2024 (KR) 10-2024-0125768

(51) Int. Cl. G06N 3/0455; G06F 18/2411; G06N 3/0985

(52) U.S. Cl. CPC G06N 3/0455; G06F 18/2411; G06N 3/0985

(57) ABSTRACT

A data diversity augmentation method includes inputting a sentence into an encoder and extracting a feature vector for the sentence, inputting the extracted feature vector into an attribute classifier to form a decision boundary for the feature vector, and moving the extracted feature vector based on the decision boundary to generate a transformed feature vector and inputting the transformed feature vector into a decoder to restore a transformed sentence for the sentence.

### CROSS-REFERENCE TO RELATED APPLICATION AND CLAIM OF PRIORITY

This application claims the benefit under 35 USC § 119 (a) of Korean Patent Application No. 10-2024-0125768 filed on Sep. 13, 2024, in the Korean Intellectual Property Office, the entire disclosure of which is incorporated herein by reference for all purposes.

### BACKGROUND

### 1. Field

The present disclosure relates to a data diversity augmentation method and device through decision boundary recognition and reconstruction.

### 2. Description of Related Art

As state-of-the-art pre-trained language models demonstrate outstanding performance, various studies have been conducted on training larger models with more data. However, due to the large number of parameters to be trained, these pre-trained language models require a significant amount of data for downstream tasks.

Data augmentation is widely used to address these problems, increasing the amount of training data to prevent overfitting. Accordingly, various data augmentation methods have been studied in various fields including computer vision, audio, and text, and these studies have proposed data augmentation methods that transform data while maintaining the properties of data as much as possible. For example, there are methods such as rotation and cutout, but for text data, basic text operations such as replacement, insertion, deletion, and shuffling are widely used. These simple data augmentation strategies enhance the robustness of models by strengthening their ability to handle noise during the optimization process.

Meanwhile, Mixup, one of the popular data augmentation techniques and is a method of creating new images by combining two or more different data, and utilizes soft labels rather than one-hot encoded ground truth labels. Through this, the learning of binary risk minimization is performed, which helps to prevent overfitting, enhance robustness against adversarial attacks, and preserve the content of each attribute.

However, Mixup, which is a method of creating a new image by combining information from different images has limitations when applied directly to the text domain. This is because images are interpreted as continuous signals, whereas sentences are composed of discrete sets of words, and thus modifying words at equal rates does not guarantee the same impact on sentence labels.

Examples of related art include Korean Registered Patent No. 10-2595573 and Korean Unexamined Patent Application Publication No. 10-2023-0007767.

### SUMMARY

Embodiments of the present disclosure are intended to provide a data diversity augmentation method and device through decision boundary recognition and reconstruction.

According to an aspect of the present disclosure, there is provided a data diversity augmentation method performed on a computing device that includes one or more processors and a memory storing one or more programs executed by the one or more processors, the method including inputting a sentence into an encoder and extracting a feature vector for the sentence, inputting the extracted feature vector into an attribute classifier to form a decision boundary for the feature vector, and moving the extracted feature vector based on the decision boundary to generate a transformed feature vector and inputting the transformed feature vector into a decoder to restore a transformed sentence for the sentence.

The generating of the transformed feature vector may include moving a position of the extracted feature vector toward the decision boundary to be brought closer to the decision boundary.

The moving of the position of the extracted feature vector toward the decision boundary may include repeatedly moving the position of the extracted feature vector toward the decision boundary according to a preset number of movements.

The position of the feature vector according to the repeated movement may be expressed by Equation 3:

$${z}^{′ ( n )} = {z}^{′ ( n - 1 )} - λ {∇}_{{z}^{′ ( n - 1 )}} {ℒ}_{cls} ( {C}_{π} ( {z}^{′ ( n - 1 )} ) , \overline{y} ) \qquad [ Equation 3 ]$$

$$where {z}^{′ ( 0 )} := z , n >= 1$$

z′(n): position of n-th moved feature vector
z′⁽ⁿ⁻¹⁾: position of (n−1)-th moved feature vector
λ: preset hyperparameter
Cπ: neural network of attribute classifier
[symbol] _{cls}: loss function of attribute classifier
y⁻: decision boundary n: number of movements of feature vector
z′⁽⁰⁾: initial position of feature vector.

The restoring of the transformed sentence may include respectively calculating probabilities of words to be inserted to complete the sentence at each point in time and determining whether to use Top-K sampling or Mid-K sampling based on the probabilities of the words.

The determining may include extracting a preset number of words having the highest probability of the words to be inserted, comparing a cumulative sum obtained by accumulating the probabilities of the extracted words with a preset threshold value, and determining whether to use Top-K sampling or Mid-K sampling according to a result of the comparison.

In the determining, if the cumulative sum is less than or equal to the preset threshold, it may be determined to use Mid-K sampling, and if the cumulative sum exceeds a preset threshold, it may be determined to use Top-K sampling.

According to another aspect of the present disclosure, there is provided a computing device that includes a processor and a memory storing one or more programs executed by the processor, the processor is configured to perform an operation of inputting a sentence into an encoder and extracting a feature vector for the sentence, an operation of inputting the extracted feature vector into an attribute classifier to form a decision boundary for the feature vector, and an operation of moving the extracted feature vector based on the decision boundary to generate a transformed feature vector, and inputting the transformed feature vector into a decoder to restore a transformed sentence for the sentence.

### BRIEF DESCRIPTION OF THE DRAWINGS

FIG. 1 is a flowchart of a data diversity augmentation method through decision boundary recognition and reconstruction according to an embodiment of the present disclosure.

FIG. 2 is a diagram illustrating the concept of gradient modification for decision boundary recognition according to an embodiment of the present disclosure.

FIG. 3 is a flowchart of a data diversity augmentation method according to an embodiment of the present disclosure.

FIG. 4 is a diagram illustrating the operation of Mid-k sampling according to an embodiment of the present disclosure.

FIG. 5 is a configuration diagram of a data diversity augmentation device through decision boundary recognition and reconstruction according to an embodiment of the present disclosure.

FIG. 6 is a block diagram for illustratively describing a computing environment including a computing device suitable for use in exemplary embodiments.

### DETAILED DESCRIPTION

Hereinafter, specific embodiments of the present disclosure will be described with reference to the drawings. The following detailed description is provided to facilitate a comprehensive understanding of the methods, apparatuses, and/or systems described herein. However, this is only an example and the present disclosure is not limited thereto.

In describing embodiments of the present disclosure, if it is determined that a specific description of a related known function of the preset invention may unnecessarily obscure the gist of the present disclosure, the detailed description thereof will be omitted. The terms described below are terms defined in consideration of the functions in the present disclosure, and vary depending on the intention or custom of the user or operator. Therefore, the definition should be made based on the contents throughout this specification. The terminology used in the detailed description is for the purpose of describing embodiments of the present disclosure only and should not be construed as limiting. Unless expressly used otherwise, singular forms include plural forms. In this description, the terms “including” or “comprising” are intended to refer to certain features, numbers, steps, operations, elements, portions or combinations thereof, and should not be construed to exclude the presence or possibility of one or more other features, numbers, steps, operations, elements, portions or combinations thereof other than those described.

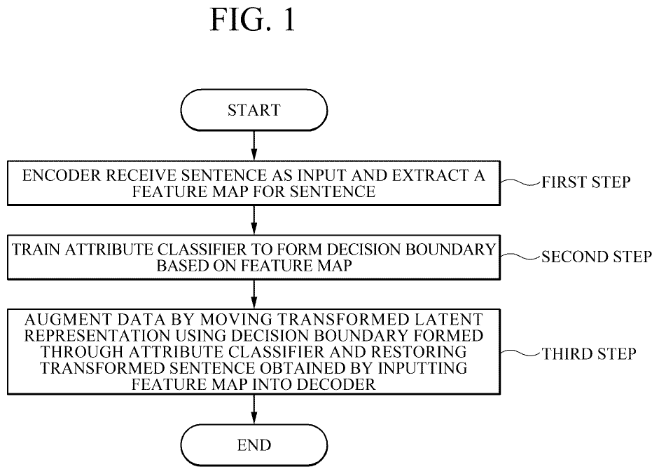

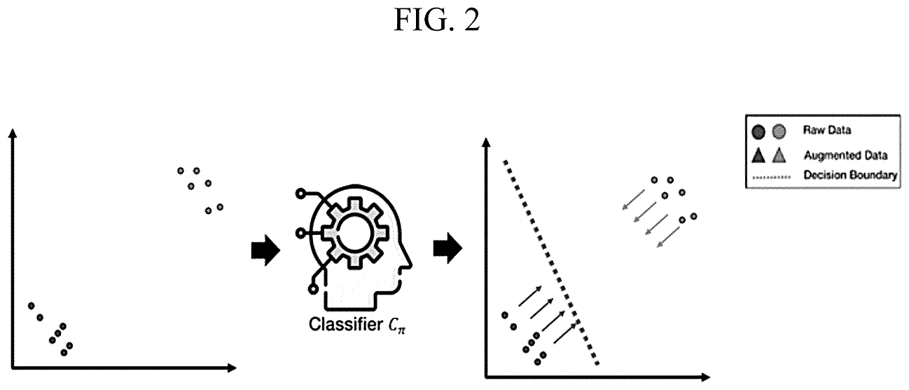

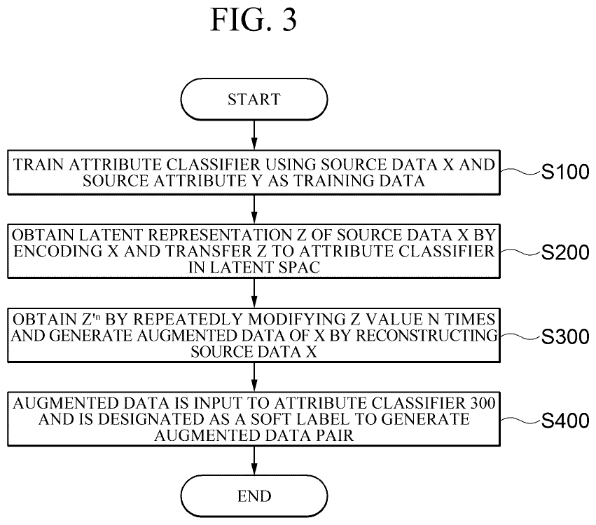

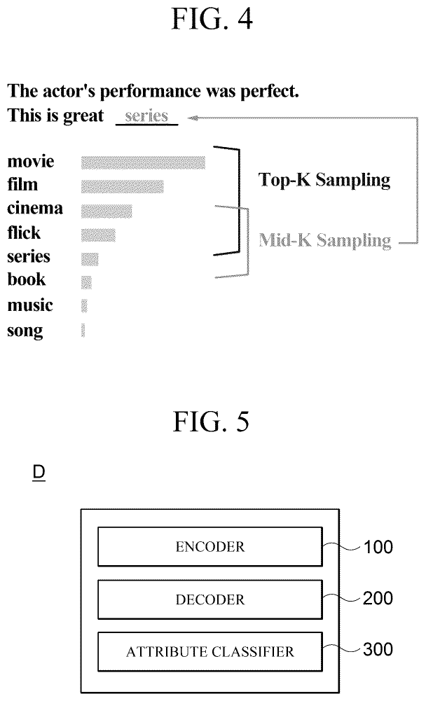

FIG. 1 is a flowchart of a data diversity augmentation method through decision boundary recognition and reconstruction according to an embodiment of the present disclosure, FIG. 2 is a diagram illustrating the concept of gradient modification for decision boundary recognition, FIG. 3 is a flowchart of a data diversity augmentation method, FIG. 4 is a diagram illustrating the operation of Mid-k sampling, and FIG. 5 is a configuration diagram of a data diversity augmentation device through decision boundary recognition and reconstruction according to an embodiment of the present disclosure.

Hereinafter, a data diversity augmentation device through decision boundary recognition and reconstruction according to the present disclosure will be described with reference to FIG. 1. This method may be performed by a data diversity augmentation device D.

First, an encoder 100 receives a sentence as input and extracts a feature map containing feature vectors for the sentence (First step).

The encoder 100 may encode a given sentence into a latent representation z. That is, the encoder 100 learns how to accurately distinguish each attribute in a latent space.

The feature map extracted in the first step is input to an attribute classifier 300, and the attribute classifier 300 is trained to form a decision boundary for each classification based on the feature map (second step).

In the second step, the decision boundary refers to a region where each class has an equal probability, and the attribute classifier 300 is trained using the latent representation z.

In the second step, the attribute classifier 300 is trained to form a decision boundary, and the decision boundary for each classification is formed through the training. In this case, the encoder 100 and the attribute classifier 300 may be trained using the loss function [symbol] _{cls} defined by Equation 1 below.

$${ℒ}_{cls} ( {C}_{π} ( {E}_{θ} ( x ) , y ; θ , π ) ) = {ε}_{cls} {\sum }_{i}^{\vert C \vert} {u}_{i} log ( {q}_{i} ) - ( 1 - {ε}_{cls} ) {\sum }_{i}^{\vert C \vert} \overline{{q}_{i}} log ( {q}_{i} ) \qquad [ Equation 1 ]$$

C_{π}: neural network that constitutes attribute classifier
E: neural network that constitutes encoder
ε_{cls}: preset label smoothing parameter
   |C|: number of classes
uᵢ: uniform noise distribution for label smoothing, defined as 1/|V|
qᵢ: actual distribution of classification (correct values)
q̅ᵢ: probability distribution predicted by attribute classifier

FIG. 2 is a diagram illustrating the concept of setting positions of feature vectors along the decision boundary direction to recognize a decision boundary and then changing the positions to be brought closer to the decision boundary.

Referring to FIG. 2, the attribute classifier (denoted as Classifier in the diagram) 300 forms an arbitrary decision boundary, enabling data to be classified. In this case, the attribute classifier 300 may form a decision boundary based on positions of feature vectors in the latent space.

The attribute classifier 300 may change the position of the feature vector so that the feature vector is brought closer to the decision boundary. After moving the feature vector position in this way toward the decision boundary direction and restoring it through the decoder 200, a sentence of a different form (i.e., a transformed sentence) is generated (i.e., data augmented) from the input sentence.

After completing the training of the attribute classifier 300 in the second step, the data is augmented by moving the position of the feature vector extracted from the encoder 100 toward the decision boundary using the decision boundary formed by the attribute classifier 300 and inputting the feature vector at the moved position into the decoder 200 to restore the transformed sentence (Third step).

In this case, restoring the transformed sentence in the decoder 300 may be performed using a loss function according to Equation 2 below.

$${ℒ}_{recon} ( {D}_{γ} ( {E}_{θ} ( x ) , x ; γ ) ) = - {\sum }_{k = 1}^{\vert N \vert} {\sum }^{\vert {x}_{k} \vert} ( ( 1 - {ε}_{recon} ) {\sum }_{i}^{\vert V \vert} \overline{{p}_{i}} log ( {p}_{i} ) + {ε}_{recon} {\sum }_{i}^{\vert V \vert} \overline{{u}_{i}} log ( {p}_{i} ) ) \qquad [ Equation 2 ]$$

Here, |N| represents the size of the training data, |xₖ| represents the length of xₖ, and |V| and |C| represent the size of the vocabulary and the number of classes, respectively. Furthermore, p̅ᵢ and q̅ᵢ represent the probability distributions predicted by the decoder 200 and the attribute classifier 300, respectively. Furthermore, pᵢ and qᵢ represent actual distributions of reconstruction and classification, respectively. Furthermore, ε_{recon} and ε_{cls} are label smoothing parameters for each loss term in sentence reconstruction and sentence classification, respectively, uᵢ represents a uniform noise distribution for label smoothing, and they are defined as 1/|V| and 1/|C|, respectively.

During training, the encoder 100 and attribute classifier 300 may be trained first using [symbol] _{cls} and then the decoder 200 may be trained using [symbol] _{recon} while keeping the parameters of the encoder 100 fixed. That is, the attribute classifier 300 and decoder 200 may be trained independently and separately. According to this model training approach, the decision boundary recognition gradient may be modified to provide enhanced data \hat{x}.

Meanwhile, in the third step, the position of the feature vector is moved closer to the decision boundary, and the feature vector may be repeatedly moved closer to the decision boundary. That is, the feature vector may be repositioned toward the decision boundary by moving its position multiple times to be brought closer to the decision boundary.

Then, the restoration of the transformed sentence in the third step may include respectively calculating probabilities of words to be inserted to complete a sentence at each time point and determining whether to use Top-K sampling or Mid-K sampling based on the probabilities of the words.

The determining whether to use Top-K sampling or Mid-K sampling may include extracting a preset number of words having the highest probability of the words, comparing a cumulative sum obtained by accumulating the probabilities of the extracted words with a preset threshold value, and determining whether to use Top-K sampling or Mid-K sampling based on a result of the comparison. In the determining, if the cumulative sum is less than or equal to the preset threshold, Mid-K sampling is used, and if the cumulative sum exceeds the preset threshold, Top-K sampling is used. A detailed description of this will be described below with reference to FIG. 4.

Here, the data augmented in the third step is text data. The reason for augmenting the data is that a model should be trained with a large amount of data to change the meaning of the text. However, due to the numerous parameters to be trained, a pre-trained language model requires a large amount of data for downstream tasks.

Hereinafter, the data diversity augmentation method will be described in more detail with reference to FIG. 3.

Referring to FIG. 3, the attribute classifier 300 is trained using source data x and source attribute y as a pair of training data in a data set (S100).

Next, after the training of the attribute classifier 300 is completed, the input source data x is encoded through the encoder 100 to obtain the latent representation z of x, and the z is transferred to the attribute classifier 300 in the latent space to obtain a classification \tilde{y} (S200). In the field of deep learning, the feature vector and the latent representation are used interchangeably, and thus, in the present disclosure, the feature vector and the latent representation are used interchangeably.

Next, based on the gradient of the decision boundary of the \tilde{y}, the latent representation z value is repeatedly modified n times to obtain a transformed latent representation z′ⁿ, and the source data x is reconstructed based on the z′ⁿ in the decoder 200 to generate augmented data \hat{x} of x (S300).

Here, to obtain a modified latent representation of the latent representation z, the gradient of the latent representation z value may be repeatedly modified n times based on the gradient of the decision boundary of \tilde{y}. Through this, the latent representation z is moved to a position closer to the decision boundary. The position of the latent representation moved closer to the decision boundary may be expressed by Equation 3 below.

$${z}^{′ ( n )} = {z}^{′ ( n - 1 )} - λ {∇}_{{z}^{′ ( n - 1 )}} {ℒ}_{cls} ( {C}_{π} ( {z}^{′ ( n - 1 )} ) , \overline{y} ) \qquad [ Equation 3 ]$$

$$where {z}^{′ ( 0 )} := z , n >= 1$$

Here, z′⁽ⁿ⁾ is the position of the n-th moved latent representation, z′⁽ⁿ⁻¹⁾ is the position of the (n−1)-th moved latent representation, n is the number of movements of the latent representation, z′⁽⁰⁾ is the initial position of the latent representation, and y̅ represents the decision boundary of the model. The decision boundary may be defined as the case where each class has equal probability (e.g., {0.5, 0.5} for a binary classification task). In addition, the λ is a preset hyperparameter, the C_{π} is a neural network of the attribute classifier 300, and [symbol] _{cls} is a loss function of the attribute classifier.

It is defined as obtaining \hat{x} for generating ambiguous data from the given source data x in S100, and the ambiguous data is defined as a value approximating the decision boundary.

According to the disclosed embodiment, it aims to weaken strong representations in the sentence by moving the latent representation of the sentence closer to the decision boundary in the feature space, and thus there is a great significant advantage in neutralizing biased representations in the original sentence.

Next, the augmented data \hat{x} is input to the attribute classifier 300 to obtain a score, and the result is designated as a soft label to generate an augmented data pair D′=\hat{x}, ŷ (S400).

In the disclosed embodiment, soft labeling may be provided during data labeling to ensure greater efficiency and accuracy during a training process. The data labeling refers to a process of assigning meaningful tags to data.

According to the present disclosure, by proceeding with the procedure of S100 to S400 as described above, data may be augmented to secure data diversity

Meanwhile, when the decoder 200 restores the sentence in the third step of FIG. 1, it may be determined whether to use Top-k sampling or Mid-k sampling. Generally, only Top-k sampling is used, but in the present disclosure, newly defined Mid-k sampling may also be used in some cases. By performing the Mid-K sampling, it is possible to generate sentences that differ from the original while preserving the core meaning and introducing variability into the sentences through data augmentation. Hereinafter, Mid-k sampling will be described with reference to the drawings. FIG. 4 is a diagram illustrating the concept of Mid-K sampling.

Referring to FIG. 4, Mid-K sampling may sample the K words having the middle rank (from cinema to series) instead of selecting the K words having the highest probability at each point in time (from movie to series in FIG. 4). This is a method of increasing the diversity of sentences generated through this Mid-K sampling.

That is, instead of calculating the probabilities of words to be inserted to complete a sentence at each point in time and selecting the K words having the highest probabilities to be calculated (this is called Top-K sampling), the K words whose probabilities to be calculated are in the middle ranks may be sampled (this is called Mid-K sampling). That is, Mid-K sampling refers to sampling the K words having probabilities that fall in the middle range, excluding a preset number of words having the highest probability and a preset number of words having the lowest probability.

Specifically, the probability of each word to be inserted to complete the sentence at each point in time may be respectively calculated, and based on the probability of the words, whether to use Top-K or Mid-K sampling may be determined.

In this case, a preset number of words having the highest probability may be extracted. Furthermore, to consider the importance of the extracted words, the cumulative sum obtained by accumulating the probabilities of the extracted words may be compared with a preset threshold. If the cumulative sum is less than the preset threshold, this indicates that the word distribution is relatively flat at this point in time. In this case, by intentionally excluding the words having the highest probability using Mid-K sampling, it is possible to generate ambiguous sentences different from the original and prevent uniformity of the generated sentences.

On the other hand, if the cumulative sum exceeds the preset threshold, the word distribution has high asymmetry. In this case, by using Top-K sampling to sample the k words having the highest probability, it is possible to preserve the core meaning of the sentence.

Conventional Top-K sampling creates simple sentences in a uniform format by preferring the words in the original sentence having the highest probability, but Mid-K sampling has the advantage of providing sentence diversity while effectively maintaining semantic consistency. That is, Mid-K sampling promotes diversity when restoring a sentence because it may generate a sentence different from the original while maintaining the core meaning and giving the sentence more variability through data augmentation.

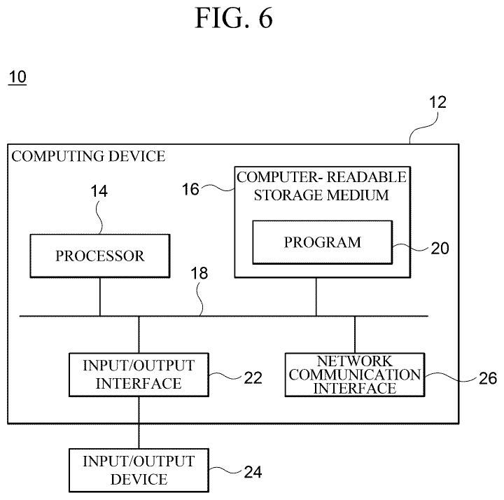

FIG. 6 is a block diagram illustrating a computing environment 10 including a computing device suitable for use in embodiments of the present disclosure. In the illustrated embodiment, respective components may have different functions and capabilities other than those described below, and include additional components in addition to those described below.

The illustrated computing environment 10 includes a computing device 12. In an embodiment, the computing device 12 may be the data augmentation device D. That is, the data augmentation device D may be implemented as the computing environment 10 as illustrated in FIG. 6.

The computing device 12 includes at least one processor 14, a computer-readable storage medium 16, and a communication bus 18. The processor 14 may cause the computing device 12 to operate according to the exemplary embodiment described above. For example, the processor 14 may execute one or more programs stored on the computer-readable storage medium 16. The one or more programs may include one or more computer-executable instructions, which, when executed by the processor 14, may be configured so that the computing device 12 performs operations according to the exemplary embodiment.

The computer-readable storage medium 16 is configured to store the computer-executable instruction or program code, program data, and/or other suitable forms of information. A program 20 stored in the computer-readable storage medium 16 includes a set of instructions executable by the processor 14. In an embodiment, the computer-readable storage medium 16 may be a memory (volatile memory such as a random access memory, non-volatile memory, or any suitable combination thereof), one or more magnetic disk storage devices, optical disk storage devices, flash memory devices, other types of storage media that are accessible by the computing device 12 and capable of storing desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 through the input/output interface 22. The exemplary input/output device 24 may include a pointing device (such as a mouse or trackpad), a keyboard, a touch input device (such as a touch pad or touch screen), a speech or sound input device, input devices such as various types of sensor devices and/or photographing devices, and/or output devices such as a display device, a printer, a speaker, and/or a network card. The exemplary input/output device 24 may be included inside the computing device 12 as a component configuring the computing device 12, or may be connected to the computing device 12 as a separate device distinct from the computing device 12.

According to the disclosed embodiment, by moving feature vectors extracted from a sentence based on a decision boundary to generate a transformed feature vector, and then restoring a transformed sentence for the sentence from the transformed feature vector, a sentence with a different expression than the original sentence can be generated while maintaining the core meaning of the original sentence, thereby promoting the increase in diversity of data.

Although representative embodiments of the present disclosure have been described in detail above, those skilled in the art will understand that various modifications may be made to the above-described embodiments without departing from the scope of the present disclosure. Therefore, the scope of the present disclosure should not be limited to the described embodiments, but should be defined not only by the patent claims described below but also by those equivalent to the patent claims.

What is claimed is:

1. A data diversity augmentation method performed on a computing device that includes one or more processors and a memory storing one or more programs executed by the one or more processors, the method comprising:
inputting a sentence into an encoder and extracting a feature vector for the sentence;
inputting the extracted feature vector into an attribute classifier to form a decision boundary for the feature vector; and
moving the extracted feature vector based on the decision boundary to generate a transformed feature vector, and inputting the transformed feature vector into a decoder to restore a transformed sentence for the sentence.

2. The data diversity augmentation method of claim 1, wherein the generating of the transformed feature vector includes moving a position of the extracted feature vector toward the decision boundary to be brought closer to the decision boundary.

3. The data diversity augmentation method of claim 2, wherein the moving of the position of the extracted feature vector toward the decision boundary includes repeatedly moving the position of the extracted feature vector toward the decision boundary according to a preset number of movements.

4. The data diversity augmentation method of claim 3, wherein the position of the feature vector according to the repeated movement is expressed by Equation:
$${z}^{′ ( n )} = {z}^{′ ( n - 1 )} - λ {∇}_{{z}^{′ ( n - 1 )}} {ℒ}_{cls} ( {C}_{π} ( {z}^{′ ( n - 1 )} ) , \overline{y} ) \qquad [ Equation ]$$
$$where {z}^{′ ( 0 )} := z , n >= 1$$
where, z′⁽ⁿ⁾: position of n-th moved feature vector
z′⁽ⁿ⁻¹⁾: position of (n−1)-th moved feature vector
λ: preset hyperparameter
Cπ: neural network of attribute classifier [symbol]
_{cls}: loss function of attribute classifier
y⁻: decision boundary
n: number of movements of feature vector
z′⁽⁰⁾: initial position of feature vector.

5. The data diversity augmentation method of claim 1, wherein the restoring of the transformed sentence includes:
respectively calculating probabilities of words to be inserted to complete the sentence at each point in time; and
determining whether to use Top-K sampling or Mid-K sampling based on the probabilities of the words.

6. The data diversity augmentation method of claim 5, wherein the determining includes:
extracting a preset number of words having the highest probability of the words to be inserted;
comparing a cumulative sum obtained by accumulating the probabilities of the extracted words with a preset threshold value; and
determining whether to use Top-K sampling or Mid-K sampling according to a result of the comparison.

7. The data diversity augmentation method of claim 6, wherein, in the determining, if the cumulative sum is less than or equal to the preset threshold, it is determined to use Mid-K sampling, and if the cumulative sum exceeds a preset threshold, it is determined to use Top-K sampling.

8. A computing device comprising:
a processor; and
a memory storing one or more programs executed by the processor,
wherein the processor is configured to perform:
an operation of inputting a sentence into an encoder and extracting a feature vector for the sentence;
an operation of inputting the extracted feature vector into an attribute classifier to form a decision boundary for the feature vector; and
an operation of moving the extracted feature vector based on the decision boundary to generate a transformed feature vector, and inputting the transformed feature vector into a decoder to restore a transformed sentence for the sentence.

9. The computing device of claim 8, wherein the operation of generating the transformed feature vector includes an operation of moving a position of the extracted feature vector toward the decision boundary to be brought closer to the decision boundary.

10. The computing device of claim 9, wherein the operation of moving the position of the extracted feature vector toward the decision boundary includes an operation of repeatedly moving the position of the extracted feature vector toward the decision boundary according to a preset number of movements.

11. The computing device of claim 10, wherein the position of the feature vector according to the repeated movement is expressed by Equation:
$${z}^{′ ( n )} = {z}^{′ ( n - 1 )} - λ {∇}_{{z}^{′ ( n - 1 )}} {ℒ}_{cls} ( {C}_{π} ( {z}^{′ ( n - 1 )} ) , \overline{y} ) \qquad [ Equation ]$$
$$where {z}^{′ ( 0 )} := z , n >= 1$$
where, z′⁽ⁿ⁾: position of n-th moved feature vector
z′⁽ⁿ⁻¹⁾: position of (n−1)-th moved feature vector
λ: preset hyperparameter
C_{π}: neural network of attribute classifier [symbol]
_{cls}: loss function of attribute classifier
y⁻: decision boundary
n: number of movements of feature vector
z′⁽⁰⁾: initial position of feature vector.

12. The computing device of claim 8, wherein the operation of restoring the transformed sentence includes:
an operation of respectively calculating probabilities of words to be inserted to complete the sentence at each point in time; and
an operation of determining whether to use Top-K sampling or Mid-K sampling based on the probabilities of the words.

13. The computing device of claim 12, wherein the operation of determining includes:
an operation of extracting a preset number of words having the highest probability of the words to be inserted;
an operation of comparing a cumulative sum obtained by accumulating the probabilities of the extracted words with a preset threshold value; and
an operation of determining whether to use Top-K sampling or Mid-K sampling according to a result of the comparison.

14. The computing device of claim 13, wherein, in the operation of determining, if the cumulative sum is less than or equal to the preset threshold, it is determined to use Mid-K sampling, and if the cumulative sum exceeds a preset threshold, it is determined to use Top-K sampling.

15. A computer program stored on a non-transitory computer readable storage medium, the computer program including one or more instructions, the instructions, when executed by a computing device having one or more processors, causing the computing device to perform:
inputting a sentence into an encoder and extracting a feature vector for the sentence;
inputting the extracted feature vector into an attribute classifier to form a decision boundary for the feature vector; and
moving the extracted feature vector based on the decision boundary to generate a transformed feature vector, and inputting the transformed feature vector into a decoder to restore a transformed sentence for the sentence.
